(19) United States
(12) Patent Application Publication
(10) Pub. No.: US 2005/0055815 A1
(43) Pub. Date: Mar. 17, 2005

(54) Method and apparatus for securing a border wire on a mattress inner spring

(76) Inventors: Scott Giett, Carthage, MO (US); Thomas J. Wells, Carthage, MO (US)

Correspondence Address: WOOD, HERRON & EVANS, LLP, 2700 CAREW TOWER, 441 VINE STREET, CINCINNATI, OH, 45202, US

(21) Appl. No.: 10/663,268

(22) Filed: Sep. 16, 2003

(51) Int. Cl. B23Q 15/00; B68G 15/00; B23P 21/00

(52) U.S. Cl. 29/91.7; 29/715; 29/818; 29/822; 29/243.56

(57) ABSTRACT

A machine for securing a border wire on a mattress inner spring comprises a support for supporting the mattress inner spring and border wire; a clip applicator for applying clips to the mattress inner spring and the border wire to secure the border wire to the mattress inner spring; a movement generating system for effecting relative movement between the mattress inner spring and border wire, and the clip applicator, such that the clip applicator successively secures clips to the mattress inner spring and the border wire around a perimeter of the mattress inner spring; a controller controlling activation and deactivation of the clip applicator and drive system; and a clip applicator feed system configured to receive and feed to the clip applicator a plurality of non-coiled strips of clips.

### FIELD OF THE INVENTION

This invention relates generally to bedding, and more particularly to machines for securing border wires onto mattress inner springs.

### BACKGROUND OF THE INVENTION

Bedding mattresses generally have border rods or wires surrounding and attached to the top and bottom surfaces of a spring assembly or inner spring. It is now a common practice to secure such border wires to the mattress inner spring by means of sheet metal clips. Machines such as those disclosed, for example, in U.S. Pat. Nos. 4,724,590, 4,815,182, 4,829,643 and 4,907,327, hereby incorporated by reference herein, have been developed for attaching the border wires to the mattress inner springs with a minimum of manual labor.

The machines illustrated and described in the first two of the above-identified patents, are so-called horizontal clip application machines wherein a bedding spring assembly and top and bottom border rods are maintained in a horizontal attitude while the spring assembly and border rods are moved as a sub-assembly and indexed past two opposed clip application stations. At each clip application station, a pair of clip application guns are operative to apply clips to the sub-assembly. In the machines disclosed in these two patents, sensors detect the presence of springs in the clip application stations, stop the indexing movement of the sub-assembly, and cause the guns to fire so as to cut endmost clips from rows of connected strips of clips and wrap those endmost cut or severed clips about the border rods and adjacent springs. This indexing and clipping process is repeated until clips are applied to the full length of opposite sides of the spring assembly. After the border rods have been clipped to two opposite sides of the spring assembly, the spring assembly and border rods are rotated 90° and then moved through a second machine to complete the application of the clips to the remaining two sides of the spring assembly.

The horizontal machines disclosed in these two patents were never commercially successful for a number of reasons, including particularly, the inability to properly position the springs relative to the border rods for simultaneous application of the sheet metal clips to opposite sides of the spring assembly, as well as the complexity and size of the machines.

The machines disclosed in the last two of the four above-identified patents are referred to as vertical clip machines in which the spring assemblies having the border rods pre-clipped thereto at the corners are supported in a vertical attitude on a bottom supporting plate and are indexed past a pair of clip application guns. These guns are located at a clip application station adjacent the bottom edge of the spring assembly. As the spring assembly and border rods move on edge past the guns, the assembly is stopped and the guns are actuated or fired to sever the endmost clips from a pair of strips of metal wire connected clips and to wrap the severed endmost clips about the border rods and edgemost springs. After the spring assemblies and border rods are clipped on one complete side, the machine is operative to rotate the assembly 90° and repeat the indexing movement of the spring assembly past the guns to clip the second, third and fourth sides of the spring assembly to the border rods.

The vertical clip application machines identified in the latter two of the four above-identified patents have been used commercially, but those machines have numerous shortcomings. Among those shortcomings is the problem of stopping the movement of the spring assembly and properly positioning the individual springs at the clip application station such that when the guns fire, the clips wrap about the border rod and adjacent spring without missing either the spring or the border rod, or both. Because of improper positioning, clips often miss the target and create voids on the spring assembly where there is no clip, but where there should be one. In that event, the end of the unclipped spring is free to move relative to the border rod. Before the spring assembly may be upholstered, this missed clip condition must be manually corrected via a hand-held gun operated by a machine operator who corrects the errors by manually applying missing clips at the missed clip sites.

Another shortcoming or problem characteristic of the vertical clip machines described in the above-identified patents is also attributable to the repeated stopping and starting of the spring assembly each time the spring assembly and border rods are indexed relative to the clip application guns. This repeated start up and stopping of the indexing movement causes substantial wear on the parts of the machine. It also results in inertial errors as a consequence of the spring assembly overrunning or underrunning the clip application station. If upon stoppage of the spring assembly, the inertia of the complete assembly and mechanism for moving the assembly causes the spring assembly to overrun or underrun the clip application station, clips will not be applied to the springs, but will miss the spring although they may wrap about the border rod, but without catching and entrapping a spring therein. To minimize this problem, clutches and brakes are applied to the drive mechanism in an attempt to compensate for this inertial error.

Yet another shortcoming or problem characteristic of the vertical clip machines described in the above-identified patents occurs as a consequence or inability of the machine to detect the presence of a spring at the clip application station. In the first three of the above-identified patents, optical sensors were utilized, but those optical sensors in many cases missed or failed to detect the presence of a spring at the clip application station. In an attempt to overcome that problem, the last of the above-identified patents utilized mechanical sensors which were positioned so as to contact the springs as they moved into the clip application station. The sensors described in this patent are electrically conductive sensors which detect and close a control circuit upon presence of the spring at the clip application station. Closing of this circuit in turn actuates a clutch and brake to stop the spring assembly and border rods at the clip application station. But these sensors require constant repositioning with each change of size or configuration of spring, a very time-consuming and difficult problem. Additionally, these mechanical sensors are subject to moving out of adjustment such that constant readjustment is required to minimize missed clips on the spring assembly.

Another shortcoming or problem encountered with the vertical clip machines described in the above-identified patents occurs as a consequence of the on-edge spring assembly traveling and being supported upon flat metal plates over which the bottom edgemost springs and border rods move. The spring assemblies are supported with the end turns of each edgemost coil spring resting upon these flat metal plates. There is a tendency for corner clips, or so-called pre-clips, applied when the corners of the border rods are pre-clipped onto the spring assembly, to catch and dig into these supporting plates, causing the unit to snag or hang up on the plates, with resulting damage to the spring assemblies and/or the machine.

Other shortcomings or problems encountered with these vertical clip machines described in the last two of the four above-identified patents are primarily attributable to the controls and the sequence of operations affected by these machines. Among those problems are excessive noise created by simultaneous actuation of numerous air cylinders and mechanical controls of the machine, frequent and difficult readjustments required to accommodate differing size and coil count units, and difficult to adjust components which are easily moved out of adjustment.

To remedy these shortcomings the machine of PCT Patent Application No. WO 97/44275, hereby incorporated by reference herein, was devised. The invention of that application which overcomes or substantially reduces the problems encountered by the prior art machines described hereinabove comprises a supporting framework for supporting mattress spring assemblies having border rods pre-clipped thereto at the corners. This supporting framework supports the spring assembly in a position angled slightly at the top away from vertical or at the rear slightly upwardly away from horizontal. In either event, the bottom edge to be clipped rests upon and is supported from a monorail which supports the spring assembly from the center portion, rather than the end portions, of the bottommost springs. The bottom edge of the spring assembly is moved continuously into and through a clip application station whereat the presence of a bottom edgemost spring is optically detected and a pair of clip application guns are actuated in sequence to apply clips to opposite ends of the spring. An encoder is attached to the drive shaft of the machine which affects movement of the spring assembly relative to the clip application stations such that programs covering differing configurations of spring assemblies having differing coil spring counts enable the operator to select, via a control monitor, the size and configuration of the unit and coil count of the unit to be processed in the machine. This encoder, in combination with fixed position sensors which seldom, if ever, need adjustment and which cannot be knocked out of alignment, enable the machine to be quickly set up and operated to apply border rods to multiple different configuration and sizes of spring assemblies.

In the machine of PCT Patent Application No. WO 97/44275, the clips are supplied to the clip application guns from a pair of rolls of collated clips rotatably supported upon the frame of the machine. A disadvantage of to this machine resides in the nature of the rolls of collated clips utilized thereby. Specifically, the collated clips are wound or coiled about a hollow tube, which tube is rotatably supported on the machine to pay out the collated clips. Inefficiencies in shipping the rolls of clips arise, first due to the circular geometry of the roll itself, and second due to the hollow tube around which the clips are wound or coiled. The geometry of the circular cross-section of a roll of clips creates voids in a container of rolls of clips to be shipped to an end customer, thereby reducing the number of clips that can be shipped per unit volume. The hollow nature of the tube further reduces the number of clips that can be shipped per unit volume. The reduced number of clips shippable per unit volume increases the shipping cost per clip.

It is desirable to devise a clip applicator feed system for the machine of PCT Patent Application No. WO 97/44275 which increases the number of clips that can be shipped per unit volume thereby reducing the shipping cost per clip.

### SUMMARY OF THE INVENTION

The present invention is a machine for securing a border wire on a mattress inner spring comprising a support for supporting the mattress inner spring and border wire; a clip applicator for applying clips to the mattress inner spring and the border wire to secure the border wire to the mattress inner spring; a movement generating system for effecting relative movement between the mattress inner spring and border wire, and the clip applicator, such that the clip applicator successively secures clips to the mattress inner spring and the border wire around a perimeter of the mattress inner spring; a controller controlling activation and deactivation of the clip applicator and drive system; and a clip applicator feed system configured to receive and feed to the clip applicator a plurality of non-coiled strips of clips.

The support can position the mattress inner spring and border wire either in a substantially vertical attitude or a substantially horizontal attitude. Preferably the support positions the mattress inner spring and border wire in a substantially vertical attitude.

The drive system can advance the mattress inner spring and border wire along the support such that the clip applicator secures clips to the mattress inner spring and the border wire along an edge of the mattress inner spring, and thereafter can rotate the mattress inner spring and border wire 90° to present another edge of the mattress inner spring and border wire to the clip applicator for application of clips thereto.

The clip applicator feed system can comprise a track along which the strips of clips travel, the track having an first feed end into which an operator feeds strips of clips and a second clip applicator end operably connected to the clip applicator for supplying clips to the clip applicator. The track can be tubular having a substantially rectangular cross-section marginally larger than a cross-section of the strip of clips. The support can comprise a first portion against which one edge of the mattress inner spring and border wire rests and a second portion against which one side of the mattress inner spring and border wires rests, and the first feed end of the track can be accessible to an operator through the second portion of the support. The track can include at least one clip feed device which moves the strips of clips along the track. The clip feed device can comprises an air cylinder. The track can include a low clip sensing device which senses a low clip condition of the clip applicator feed system. The low clip sensing device can comprise a proximity switch. Preferably the track includes a pair of the clip feed devices, and a low clip sensing device disposed between the pair of clip feed devices.

Preferably the machine comprises a pair of clip applicators for applying clips to the mattress inner spring and a pair of border wires positioned in opposed relation on opposite sides thereof to secure the border wires to the mattress inner spring.

In another aspect, the invention is a machine for securing a border wire on a mattress inner spring comprising a support for supporting the mattress inner spring and border wire; a clip applicator for applying clips to the mattress inner spring and the border wire to secure the border wire to the mattress inner spring; a movement generating system for effecting relative movement between the mattress inner spring and border wire, and the clip applicator, such that the clip applicator successively secures clips to the mattress inner spring and the border wire around a perimeter of the mattress inner spring; a clip applicator feed system configured to receive and feed to the clip applicator a plurality of non-coiled strips of clips; and a controller controlling activation and deactivation of the clip applicator, movement generating system and clip applicator feed system.

The primary advantage of the invention is that, by devising a machine which accepts strips of non-coiled clips, the machine's clip shipping density is increased. For the prior coiled clip machine of PCT Patent Application No. WO 97/44275, 48 rolls of clips were typically shipped on a pallet. The resulting dimensions of the 48 rolls of palletized clips were 46 inches by 46 inches by 36 inches, or 44.1 cubic feet. With each roll having 12,300 clips thereon, the clip shipping density was 13,388 clips per cubic foot. With the machine of this invention accepting strips of non-coiled clips, 6,400 strips of clips can be palletized in a volume of 44 inches by 45 inches by 20 inches, or 22.92 cubic feet. With each strip having 75 clips thereon, the clip shipping density is 20,945 clips per cubic foot, a 56 percent increase over the rolls of clips of the prior machine.

These and other advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of the machine of this invention;

FIG. 2 is an end view of the machine of FIG. 1; and

FIG. 3 is an enlarged end view of a clip applicator feed system of the machine of FIGS. 1 and 2.

### DETAILED DESCRIPTION OF THE INVENTION

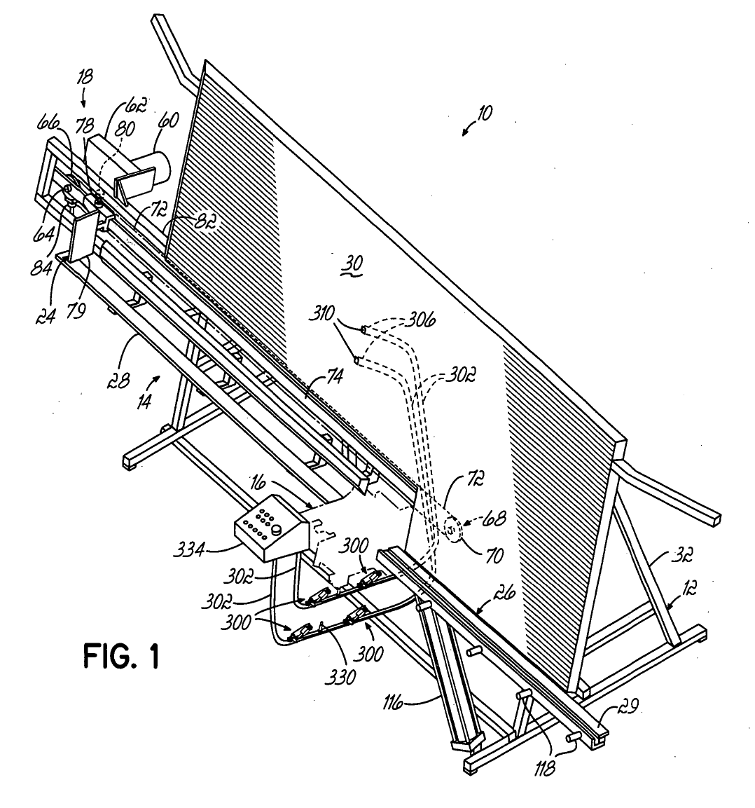

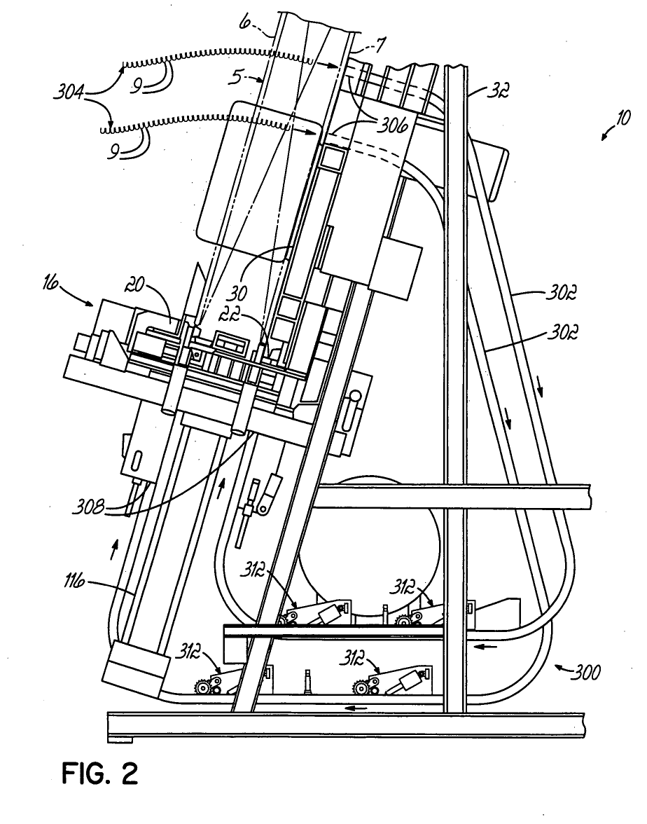

Referring to FIGS. 1 and 2, the clip application machine 10 of this invention comprises a supporting framework 12 which includes a spring assembly support 14. This spring assembly support 14 maintains a spring assembly 5 in an upright on-edge attitude in the course of its movement through the machine 10. In the course of movement through the machine 10, pre-formed and generally U-shaped sheet metal clips 9 are applied and wrapped about the border rods 6 and springs as the border rods and springs pass through a clip application station 16. To effect this movement of the spring assembly 5 over the support 14 and through the clip application station 16, there is a drive mechanism 18 associated with the support which includes a pusher or pusher assembly 24 operative to contact the rear edge of the assembly 5 and push the spring assembly over the support at a controlled speed and feed rate. As the individual bottom edgemost springs of the spring assembly enter into the clip application station 16, their presence is detected by an optical sensor which, through an appropriate control circuit, then triggers sequential actuation of a pair of longitudinally offset clip application guns 20, 22 at the clip-wrapping station 16. The machine 10 applies the clips on the fly while the spring assembly continues to move at a fixed rate through the clip application station. After clips 9 have been applied to one complete side of the spring assembly 5, forward movement of the pusher 24 and the spring assembly is stopped, the pusher 24 is moved rearwardly, and the complete spring assembly 5 is rotated 90° by a rotating mechanism 26. After rotation of the spring assembly 5 through the full 90°, the spring assembly 5 again rests upon the spring assembly support 14, at which time the pusher assembly 24 again moves into contact with the rear edge of the spring assembly 5. The pusher assembly 24 then proceeds to push the second side of the spring assembly 5 through the clip application station 16 whereat clips 9 are applied to springs 8 and border rods 6 along the complete second side of the spring assembly. This process is then repeated for the third and fourth sides of the spring assembly 5, after which the spring assembly 5 is physically removed from the clip machine 10 preparatory to reception of a new spring assembly 5 onto the machine 10.

The spring assembly 5 to which sheet metal clips are applied in accordance with the practice of this invention comprises a plurality or matrix of springs (not shown) arranged in rows and columns and interconnected, as for example, by conventional helical lacing wires. These springs may be conventional knotted or unknotted springs, individual cylindrical springs, or multiple springs or so-called continuous springs in which a complete row of springs is formed from a single length of wire. The configuration of the springs is of no significance to the practice of this invention. To this array or matrix of springs, a first border wire 6 is applied and surrounds one side of the matrix, and a second border wire 7 surrounds and is attached to the opposite side. According to the practice of this invention, these border wires are pre-clipped by clips 9 at the corners to the spring matrix to form a spring assembly preparatory to being inserted into the machine 10. This pre-clipping of the springs may involve only pre-clipping of the cornermost springs or pre-clipping of three springs, one on each side of the comermost spring at each corner of the spring matrix.

In the course of movement through the machine 10, the spring assembly 5 is supported from a bottom monorail 28 and a rear supporting plate 30. The rear supporting plate 30 is angled or tilted at an angle of approximately 15° from the vertical plane such that the top edge of the plate 30 is spaced rearwardly from the lower edge by the 15° angle. These supporting elements, the monorail 28 and rear support plate 30, are in turn supported from a generally A-shaped frame 32.

The drive mechanism 18 for advancing a spring assembly 5 continuously into and through the clip application station 16 comprises a drive motor 60 operative to drive via a transmission 62, an output drive shaft 64, all of which are mounted upon and supported from the framework 12 of the machine. The transmission 62 may be a direct belt and sprocket drive, or a gear drive, or some other drive linkage that transmits power from the motor 60 to the shaft 64 at an appropriate speed ratio. The output shaft 64 of the transmission 62 is operative to drive a sprocket 66 of an endless chain drive 68, which includes an idler sprocket 70. The chain drive 68 includes an endless chain 72 movable between the drive sprocket 66 and the idler sprocket 70. This chain drive runs in parallel with a framework supported horizontal guide rail 74 over which the pusher 24 is movable. The pusher 24 is fixedly attached to one run of the chain drive, such that as the pusher moves over the guide rail 74 and between the sprockets 66, 70, it causes the pusher to move lengthwise of the machine. In the course of moving lengthwise of the machine, a forwardly extending arm or pusher plate 79 mounted upon the pusher 24 engages the trailing side of the spring assembly 5 and causes that spring assembly 5 to move with the pusher 24 forwardly over the monorail 28. Also mounted on the pusher 24 is an actuating pin 78 cooperable with a sensor 80 mounted on a rail 82 of the framework 12 to initially position the pusher 24 on the guide rail 74. When the actuating pin 78 is positioned immediately adjacent to the sensor 80, the pusher is zeroed relative to an encoder 84 which is driven from the drive shaft 64 of the drive mechanism. As the drive shaft 64 is rotated, it caused the encoder to rotate and feed a position signal to the processor/controller 334 of the machine 10.

There are two clip application guns 20, 22 located at the clip application station 16 to clip opposed border wires 6 and 7 to the spring assembly 5. These guns 20, 22 are longitudinally offset one from the other such that the guns fire sequentially rather than simultaneously to apply a pair of clips to a single spring as that spring passes through the clip application station 16. These guns are adjustably mounted upon the framework 12, but once adjusted, are intended to remain in a fixed position on the frame, such that no further adjustment will be needed even when the machine is converted from one size spring assembly to another or from one coil count of springs in an assembly to another coil count. The clip guns 20, 22 are conventional clipping guns operative to clip a conventional three-pronged clip 9 onto the border rod and spring of a spring assembly 5. One such gun suitable for use in this application is that disclosed in U.S. Pat. No. 4,546,528, hereby incorporated by reference herein. Other guns suitable for use in the machine 10 are disclosed in the patents identified in the preamble of this application. These guns 20, 22 each comprise a gun body having a pneumatic actuator operable to move a reciprocable blade and forming die relative to a stationary anvil so as to sever an endmost clip 9 from a strip of clips and wrap a single clip about a border wire and spring capture between the forming die and anvil of the gun. A typical and preferred three-prong clip 9 utilized in the practice of this invention is illustrated and described in U.S. Pat. Nos. 5,303,821 and 5,314,065, hereby incorporated by reference herein.

After all of the springs on one side of the spring assembly 5 have moved through the clip application station 16, the pusher assembly 24 continues to push the spring assembly forwardly on the monorail 28 until the trailing edge of the assembly has passed through the clip application station and onto a monorail 29 of a spring assembly rotating assembly 26. The monorail 29 has an upstream end thereof pivotally connected to the framework of the machine by a pivot shaft 114. An air cylinder 116 extends between the monorail 29 and the machine frame, such that upon extension of the cylinder 116, the monorail 29 is caused to pivot from a horizontal attitude to a vertical attitude about the pivot shaft 114. This pivoting movement of the monorail 29 occurs only after a spring assembly has moved onto the arm with the springs of the spring assembly supported from the top surface of the monorail 29. After the spring assembly has been moved onto the monorail 29 such that it is supported solely in the rotating mechanism 26 pneumatically actuated clamp cylinders 118 associated with the arm and supported therefrom are actuated so as to cause the pistons of the cylinders to be pulled outwardly, thereby to clamp the border rods 6 of the spring assembly between the monorail 29 and the pistons of the cylinders. So clamped, the spring assembly may be rotated 90° from the horizontal to the vertical. Prior to this rotational movement, the pusher assembly 24 is moved rearwardly out of an interfering position relative to the spring assembly, such that the spring assembly 5 may be freely rotated 90° by rotation of the monorail 29. The pusher 24 is moved rearwardly only so far as is required to avoid interference with the rotation of the spring assembly 5 through 90°. The distance the pusher assembly 24 is moved rearwardly is a function of the configuration of the mattress and the length of the side of the mattress to next be clipped in the clipping station 16 of the machine 10.

The primary machine elements that are controlled in the operation of the machine 10 by processor/controller 334 are the pusher assembly 24, the monorail 29 of the rotating mechanism 26, the clamp cylinders 108, 110, the spreader pins 104, 106, the clip applicator guns 20, 22 and a fault indicator (not shown).

Additional details of the basic machine comprising mattress support, clip applicator, drive system, rotating system and control system may be seen with reference to PCT Patent Application No. WO 97/44275.

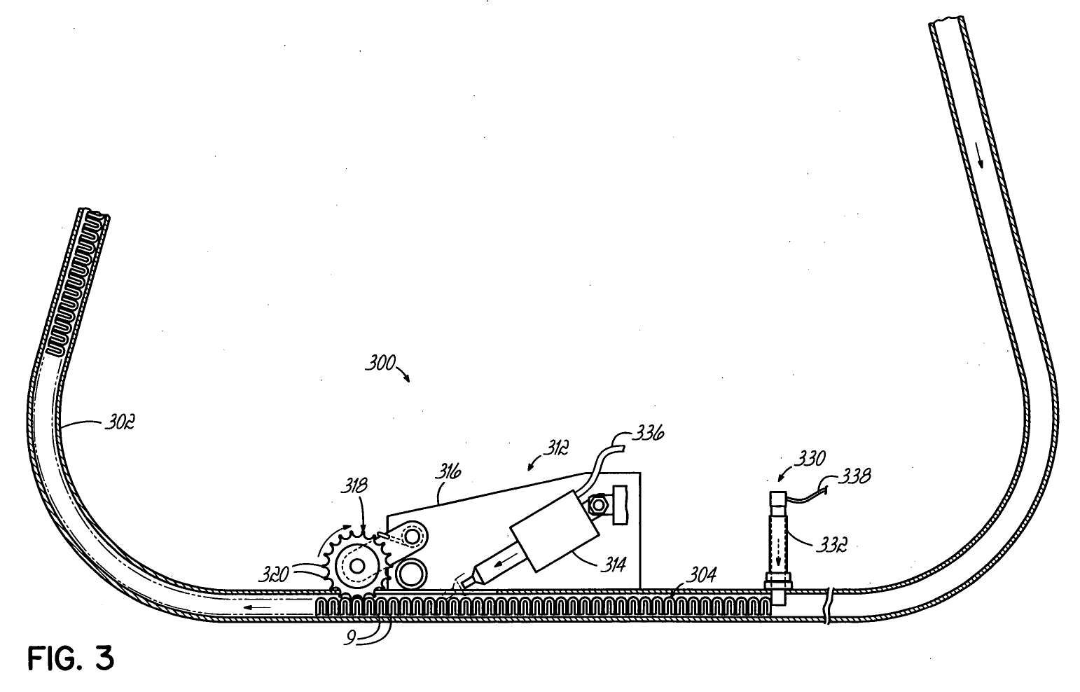

Referring still to FIGS. 1 and 2, and now to FIG. 3 as well, there are illustrated a pair of clip applicator feed systems 300, 300 for the machine 10, one such clip applicator feed system 300 for each clip application gun 20, 22. The clip applicator feed system 300 can comprise a track 302 along which the strips 304 of clips travel. The strips 304 of clips are preferably 22 inches long, each including 75 clips. The track 302 can have a first feed end 306 into which an operator feeds the strips of clips and a second clip applicator end 308 operably connected to the clip applicator gun 20 or 22 for supplying clips 9 to the clip applicator. The track 300 can be tubular and have a cross-section that is substantially rectangular, and marginally larger than a cross-section of the strip 304 of clips 9. The first feed end 306 of the track 300 can be accessible to an operator through an aperture 310 in the supporting plate 30.

The track 302 can include at least one clip feed device 312 which moves the strips 304 of clips 9 along the track 300. The clip feed device 312 can comprise an air cylinder 314 connected to a bracket 316 mounted to track 302, and a roller clutch or one-way ratchet sprocket 318 rotatably connected to the bracket 316. Air cylinder 314 can be, for example, one available from Vertex Fasteners Inc., of Skokie, Ill., as part number VC0278. The teeth 320 of sprocket 318 engage between individual ones of the clips 9 of a strip 304 of clips. Ratchet sprocket 318 is free to move clockwise but is not free to move counterclockwise, thus preventing the strip 304 of clips 9 from sliding backward after having been advanced by the piston 322 of the air cylinder 314. Ratchet sprocket 318 can be selectively pivoted upwardly and out of engagement with the clips 9 of the strip 304 in the event there is a jam and the clips 9 need to be slid backwards.

The track 302 can also include a low clip sensing device 330 which senses a low clip condition of the clip applicator feed system 300. The low clip sensing device 330 can comprise a proximity switch 332. Proximity switch 332 can be, for example, one available from Allen Bradley, of Milwaukee, Wis., as part number 872C-D3NE12-D4.

Both the air cylinder 314 and proximity switch 332 send and receive signals to and from the processor/controller 334 via leads 336 and 338, respectively. The processor/controller 334 controls activation and deactivation of air cylinder 314 in cooperation with control of activation and deactivation of applicator guns 20, 22, drive system 18 and rotating system 26. Proximity switch 332 is operable to send a low clip signal to processor/controller 334 for display to an operator, indicating that the operator needs to feed more strips 304 of clips 9 into the feed system(s) 300.

By devising the machine of the present invention which accepts strips of non-coiled clips, the machine's clip shipping density is increased over that of the prior coiled clip machine of PCT Patent Application No. WO 97/44275. For the prior coiled clip machine, 48 rolls of clips were typically shipped on a pallet. The resulting dimensions of the 48 rolls of palletized clips were 46 inches by 46 inches by 36 inches, or 44.1 cubic feet. With each roll having 12,300 clips thereon, the clip shipping density was 13,388 clips per cubic foot. With the machine of this invention accepting strips of non-coiled clips, 6,400 strips of clips can be palletized in a volume of 44 inches by 45 inches by 20 inches, or 22.92 cubic feet. With each strip having 75 clips thereon, the clip shipping density is 20,945 clips per cubic foot, a 56 percent increase over the rolls of clips of the prior machine.

Those skilled in the art will readily recognize numerous adaptations and modifications which can be made to the present invention which will result in an improved method and apparatus for securing a border wire on a mattress inner spring, yet all of which will fall within the spirit and scope of the present invention as defined in the following claims. Accordingly, the invention is to be limited only by the scope of the following claims and their equivalents.

1. A machine for securing a border wire on a mattress inner spring comprising:
a support for supporting the mattress inner spring and border wire;
a clip applicator for applying clips to the mattress inner spring and the border wire to secure the border wire to the mattress inner spring;
a movement generating system for effecting relative movement between the mattress inner spring and border wire, and said clip applicator, such that said clip applicator successively secures clips to the mattress inner spring and the border wire around a perimeter of the mattress inner spring;
a controller controlling activation and deactivation of said clip applicator and movement generating system; and
a clip applicator feed system configured to receive and feed to said clip applicator a plurality of non-coiled strips of clips.

2. The machine of claim 1 wherein said support positions the mattress inner spring and border wire in one of a substantially vertical attitude and a substantially horizontal attitude.

3. The machine of claim 1 wherein said support positions the mattress inner spring and border wire in a substantially vertical attitude.

4. The machine of claim 1 wherein said movement generating system advances the mattress inner spring and border wire along said support such that said clip applicator secures clips to the mattress inner spring and the border wire along an edge of the mattress inner spring, and thereafter rotates the mattress inner spring and border wire 90° to present another edge of the mattress inner spring and border wire to said clip applicator for application of clips thereto.

5. The machine of claim 1 wherein said clip applicator feed system comprises a track along which the strips of clips travel, said track having an first feed end into which an operator feeds strips of clips and a second clip applicator end operably connected to said clip applicator for supplying clips to said clip applicator.

6. The machine of claim 5 wherein said track is tubular having a substantially rectangular cross-section marginally larger than a cross-section of the strip of clips.

7. The machine of claim 5 wherein said support comprises a first portion against which one edge of the mattress inner spring and border wire rests and a second portion against which one side of the mattress inner spring and border wire rests, and wherein said first feed end of said track is accessible to an operator through said second portion of said support.

8. The machine of claim 5 wherein said track includes at least one clip feed device which moves the strips of clips along said track.

9. The machine of claim 8 wherein said clip feed device comprises a air cylinder.

10. The machine of claim 5 wherein said track includes a low clip sensing device which senses a low clip condition of said clip applicator feed system.

11. The machine of claim 10 wherein said low clip sensing device comprises a proximity switch.

12. The machine of claim 5 wherein said track includes a pair of clip feed devices which move the strips of clips along said track, and a low clip sensing device, disposed between said pair of clip feed devices, which senses a low clip condition of said clip applicator feed system.

13. The machine of claim 12 wherein said clip feed devices comprise air cylinders, and said low clip sensing device comprises a proximity switch.

14. The machine of claim 1 wherein the mattress inner spring has a pair of border wires positioned in opposed relation on opposite sides thereof, and wherein said machine comprises a pair of clip applicators for applying clips to the mattress inner spring and the pair of border wires to secure the border wires to the mattress inner spring.

15. A machine for securing a border wire on a mattress inner spring comprising:
a support for supporting the mattress inner spring and border wire;
a clip applicator for applying clips to the mattress inner spring and the border wire to secure the border wire to the mattress inner spring;
a movement generating system for effecting relative movement between the mattress inner spring and border wire, and said clip applicator, such that said clip applicator successively secures clips to the mattress inner spring and the border wire around a perimeter of the mattress inner spring;
a clip applicator feed system configured to receive and feed to said clip applicator a plurality of non-coiled strips of clips; and
a controller controlling activation and deactivation of said clip applicator, movement generating system and clip applicator feed system.

16. The machine of claim 15 wherein said support positions the mattress inner spring and border wire in one of a substantially vertical attitude and a substantially horizontal attitude.

17. The machine of claim 15 wherein said support positions the mattress inner spring and border wire in a substantially vertical attitude.

18. The machine of claim 15 wherein said movement generating system advances the mattress inner spring and border wire along said support such that said clip applicator secures clips to the mattress inner spring and the border wire along an edge of the mattress inner spring, and thereafter rotates the mattress inner spring and border wire 90° to present another edge of the mattress inner spring and border wire to said clip applicator for application of clips thereto.

19. The machine of claim 15 wherein said clip applicator feed system comprises a track along which the strips of clips travel, said track having an first feed end into which an operator feeds strips of clips and a second clip applicator end operably connected to said clip applicator for supplying clips to said clip applicator.

20. The machine of claim 19 wherein said track is tubular having a substantially rectangular cross-section marginally larger than a cross-section of the strip of clips.

21. The machine of claim 19 wherein said support comprises a first portion against which one edge of the mattress inner spring and border wire rests and a second portion against which one side of the mattress inner spring and border wire rests, and wherein said first feed end of said track is accessible to an operator through said second portion of said support.

22. The machine of claim 19 wherein said track includes at least one clip feed device which moves the strips of clips along said track.

23. The machine of claim 22 wherein said clip feed device comprises a air cylinder.

24. The machine of claim 19 wherein said track includes a low clip sensing device which senses a low clip condition of said clip applicator feed system.

25. The machine of claim 24 wherein said low clip sensing device comprises a proximity switch.

26. The machine of claim 19 wherein said track includes a pair of clip feed devices which move the strips of clips along said track, and a low clip sensing device, disposed between said pair of clip feed devices, which senses a low clip condition of said clip applicator feed system.

27. The machine of claim 26 wherein said clip feed devices comprise air cylinders, and said low clip sensing device comprises a proximity switch.

28. The machine of claim 15 wherein the mattress inner spring has a pair of border wires positioned in opposed relation on opposite sides thereof, and wherein said machine comprises a pair of clip applicators for applying clips to the mattress inner spring and the pair of border wires to secure the border wires to the mattress inner spring.
